(19) United States
(12) Patent Application Publication
(10) Pub. No.: US 2026/0218606 A1
(43) Pub. Date: Jul. 30, 2026

(54) CLOSED LOOP BORESIGHT ADJUSTMENT (CLBA) RETRO-REFLECTOR SYSTEM AND METHOD OF OPERATING RETRO-REFLECTOR SYSTEM

(71) Applicant: NORTHROP GRUMMAN SYSTEMS CORPORATION, Falls Church, VA (US)

(72) Inventors: George W. GIGIOLI, Brookeville, MD (US); Fred F. FROEHLICH, Baltimore, MD (US)

(73) Assignee: NORTHROP GRUMMAN SYSTEMS CORPORATION, Falls Church, VA (US)

(21) Appl. No.: 19/038,237

(22) Filed: Jan. 27, 2025

(51) Int. Cl. E21B 47/135; G02B 5/122; G03B 43/00

(52) U.S. Cl. CPC E21B 47/135; G03B 43/00; G02B 5/122

(57) ABSTRACT

The closed loop boresight adjustment (CLBA) retro-reflector system permits the detector element (or pixel) on a focal plane array (FPA) that is aligned with the receiver fiber to be determined in real time, during transmitting and receiving of rays, by sensing the amplified spontaneous emission (ASE) emitted by the receiver fiber and reflected by the modified retro-reflector device, without superimposition of the ASE signal and the signal from a target or remote terminal on the FPA. The modified retro-reflector device produces multiple images of the receive fiber that are separated from the image of the target or remote terminal on the FPA, so that the centroids of these images can be determined independently, while still allowing the alignment to be maintained in real time.

### BACKGROUND

In bidirectional optical systems, such as a coherent LADAR or LIDAR (“laser imaging, detection, and ranging” or “light detection and ranging”) or a free-space optical communication (FSOC) system that couple incoming light into a “receive” fiber it is critical for the outgoing (transmit) beam and the incoming (receive) beam to be coaligned, although they propagate in opposite directions. Furthermore, it is critical that the incoming beam is simultaneously aligned with the optical system boresight and with the receive fiber in order to maintain stable pointing and efficient coupling of light into the receive fiber, respectively. A pointing/acquisition/track (PAT) camera uses a portion of the incoming beam, split off by a beam splitter, to measure the angle of the incoming beam with respect to a “boresight” pixel in the focal plane array (FPA) of the PAT camera, and a steering mirror, such as a fast steering mirror (FSM) or a gimbal mirror, steers the beam to place the focused incoming beam precisely on the boresight pixel. This boresight pixel must correspond to the conjugate image of the receiver fiber in order for the remaining portion of the incoming beam to be coupled into the receiver fiber efficiently.

Therefore, there is a need to co-align the receiver fiber and the boresight pixel of the FPA. This coalignment can be accomplished during integration using special alignment/test equipment. But such a one-time coalignment may be inadequate to maintain efficient coupling in the presence of thermal and shock/vibration environments. Therefore, a built-in, real-time, closed-looped alignment subsystem is needed.

### SUMMARY

The disclosed invention provides a closed loop boresight adjustment (CLBA) retro-reflector system, in order to address the need of a built-in, real-time, closed-looped alignment of the receive fiber and the boresight pixel of the FPA. The CLBA retro-reflector system includes a modified retro-reflector device that is configured to create multiple beams from a single collimated incident beam. The multiple beams created by the retro-reflector device of the disclosed invention propagate in a circularly symmetric pattern, in a direction opposite that of the single collimated incident beam. The center of this symmetric pattern can be used to precisely gauge the direction of the single collimated incident beam, for example, by focusing the multiple beams onto a single focal plane and computing the geometric center of the pattern of focused spots, thereby permitting precise measurement and/or control of the direction of the single collimated incident beam.

These advantages and others are achieved, for example, by a closed loop boresight adjustment (CLBA) retro-reflector system that includes a beam splitter that receives an incoming beam from a target or a remote terminal, a receiver fiber that receives the first split incoming beam, a corner reflector including a first facet, a second facet, and a third facet that are configured to reflect rays, and a pointing/acquisition/track (PAT) camera comprising a focal plane array (FPA). The beam splitter is configured to split the incoming beam into a first split incoming beam and a second split incoming beam. The receiver fiber is configured to generate an amplified spontaneous emission (ASE) beam propagating toward the beam splitter. The first, second, and third facets are not mutually perpendicular to reflect an incident ray into multiple reflected rays. The corner reflector is arranged to receive the ASE beam from the beam spitter and to reflect the received ASE beam toward the beam splitter. The PAT camera is arranged to receive the second split incoming beam on the FPA and to receive on the FPA a first reflected split ASE beam that is reflected from the corner reflector and split by the beam splitter.

A first angle between the second and third facets, a second angle between the first and third facets, and a third angle between the first and second facets are acute angles or obtuse angles, and are the same. A first angle between the second and third facets, a second angle between the first and third facets, and a third angle between the first and second facets are acute angles or obtuse angles, and some or all of the first, second, and third angles are different from each other. The corner reflector is constructed as a solid prism made of a transparent refractive material. A surface of the face facet is formed with an anti-reflection coating. The CLBA retro-reflector system further includes a receiver channel connected to the receiver fiber, and the receiver channel is configured to obtain information carried by the incoming beam. The CLBA retro-reflector system further includes a beam steerer that reflects the incoming beams from the target or the remote terminal and directs the reflected beam to the beam splitter. The PAT camera is configured to perform alignment processes including the steps of finding a center point of spot images of the first reflected split ASE beam on the FPA, locating a boresight pixel on the FPA by using the center point, measuring a deviation angle between the second split incoming beam and the boresight pixel on the FPA, and controlling the beam steerer to steer the incoming beam to place the incoming beam on the boresight pixel on the FPA.

These advantages and others are achieved, for example, by a method to align an incoming beam with a boresight pixel on a focal plane array (FPA) of a pointing/acquisition/track (PAT) camera. The method includes steps of receiving, via a beam splitter, the incoming beam from a target or a remote terminal, splitting, via the beam splitter, the received incoming beam into a first split incoming beam and a second split incoming beam, receiving, via a receiver fiber, the first split incoming beam, receiving, via a corner reflector, the ASE beam from the beam spitter, reflecting, via the corner reflector, the received ASE beam toward the beam splitter, receiving, via the FPA, the second split incoming beam and a first reflected split ASE beam that is reflected from the corner reflector and split by the beam splitter, and performing alignment processes to align the incoming beam with the boresight pixel on the FPA. The receiver fiber is configured to generate an amplified spontaneous emission (ASE) beam propagating toward the beam splitter. The corner reflector comprises a first facet, a second facet, and a third facet that are configured to reflect rays, wherein the first, second, and third facets are not mutually perpendicular to reflect an incident ray into multiple reflected rays.

### BRIEF DESCRIPTION OF THE DRAWINGS

The preferred embodiments described herein and illustrated by the drawings hereinafter are included to illustrate and not to limit the invention, where like designations denote like elements.

FIG. 1A shows an exemplary illustration of a conventional corner reflector that reflects all incident rays in the opposite direction of the incident ray, regardless of the incidence angle.

FIG. 1B shows the illustration of the section A shown in FIG. 1A.

FIG. 2A shows an exemplary illustration of a modified corner reflector of the disclosed invention that is employed in the closed loop boresight adjustment (CLBA) retro-reflector system of the disclosed invention.

FIG. 2B shows the illustration of the section B shown in FIG. 2A.

FIGS. 3A-3B illustrate exemplary diagrams of the modified corner reflector of the disclosed invention showing a front view and a side view, respectively.

FIG. 4 shows an exemplary diagram of retro-reflector system illustrating how a conventional corner reflector can be used to create an image of the receiver fiber on the focal plane array (FPA) which defines the boresight pixel location, thereby achieving a coalignment of the receiver fiber and boresight pixel of focal plane array (FPA) of a pointing/acquisition/track (PAT) camera.

FIG. 5 shows an exemplary diagram of the CLBA retro-reflector system of the disclosed invention that utilizes the modified corner reflector (shown in FIGS. 2A-2B) of the disclosed invention.

FIGS. 6A-6B are illustrations showing how the reflected split ASE beams make multiple spots on the FPA of the PAT camera.

FIG. 7A is a workflow diagram of a method of the disclosed invention for aligning an incoming beam with a boresight pixel on a FPA of a PAT camera.

FIG. 7B is a workflow diagram of steps included in the step S607 shown in FIG. 7A.

### DETAILED DESCRIPTION

The following detailed description is merely exemplary in nature and is not intended to limit the described embodiments or the application and uses of the described embodiments. All of the implementations described below are exemplary implementations provided to enable persons skilled in the art to make or use the embodiments of the disclosure and are not intended to limit the scope of the disclosure, which is defined by the claims. It is also to be understood that the drawings included herewith only provide diagrammatic representations of the presently preferred structures of the present invention and that structures falling within the scope of the present invention may include structures different than those shown in the drawings.

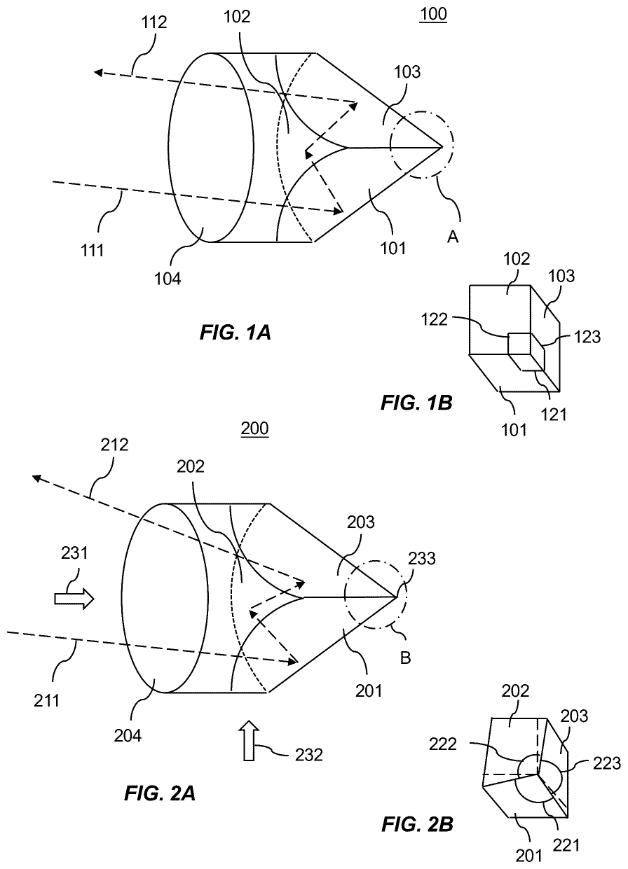

With reference to FIG. 1A, shown is an exemplary illustration of a conventional corner reflector 100 that reflects all incident rays 111, incident at angles within the acceptance angle of the device, in the opposite direction of the incident ray, regardless of the incidence angle. With reference to FIG. 1B, shown is the illustration of the section A shown in FIG. 1A. The corner reflector 100 includes three reflective surfaces or facets 101-103 that are mutually perpendicular. The facet angles 121, 122, and 123 between the facets 102 and 103, facets 101 and 103, and facets 101 and 102, respectively, are right angles (90 degrees). The incident rays 111 enter the corner reflector 100 through the face facet 104 and make three reflections inside the corner reflector 100, one from each of the perpendicular facets 101-103, before exiting the corner reflector 100 in the exact opposite direction as reflected rays 112. The corner reflector 100 can either be a hollow configuration of surface mirrors or a solid prism made of a transparent refractive material in which case the rays experience total internal reflection at the three facets. FIG. 1A exemplarily shows a solid prism type corner reflector 100.

Because there are three reflective surfaces 101-103 (‘1’, ‘2’ and ‘3’), there are six possible sequences of reflection from the three surfaces: 1-2-3, 1-3-2, 2-3-1, 2-1-3, 3-1-2, and 3-2-1, each producing a distinct retro-reflection. For example, the sequence “1-2-3” means that the incident ray 111 is reflected from the first facet 101 toward the second facet 102, is reflected from the second facet 102 toward the third facet 103, and then is reflected from the third facet 103 toward the face facet 104 and exits the corner reflector 100, as a retro-reflected ray 112, in the opposite direction of the incident ray 111.

These six reflection sequences comprise six contiguous beam segments that, when combined after reflection, form a single retro-reflected beam 112 that replicates the incident beam 111 travelling in the opposite direction. Small errors in the angles of the reflective facets lead to small deviations among the six retro-reflected beam segments. The deviations in the angles among the retro-reflected beams are, typically, larger than the facet angle errors. However, for most practical applications, facet errors (and consequently, beam segment deviation errors) due to common optical prism manufacturing capabilities are negligible, and therefore tolerable. There are different levels of precision of prism manufacture available, depending on the desired retro-reflection precision in return for manufacturing cost.

In a LADAR or FSOC system that utilizes a camera sensor with a focal plane array (FPA) in a pointing/acquisition/track (PAT) function, it is necessary to know which detector element (or pixel) of the FPA corresponds to the exact point in the LADAR or FSOC system's field of view (FoV) corresponding to the receiver fiber's core. This allows for a tracker function that utilizes conventional spot centroiding methods with the FPA's output signal to determine the position of the remote target or terminal in the FoV, and command the LADAR's or FSOC's pointing system to align the receiver fiber with the image of the remote target or terminal so that the signal from the remote target or terminal can be detected with minimum loss.

The closed loop boresight adjustment (CLBA) retro-reflector device of the disclosed invention utilizes a corner reflector that is modified such that a prescribed, fixed radial angular offset is introduced in each of the reflective facets, so that the reflective facets are no longer mutually perpendicular. The result is that the six segments of the retro-reflected beam propagate at a deterministic radial angle with respect to the axis of symmetry for a given facet angle offset.

With reference to FIG. 2A, shown is an exemplary illustration of a modified corner reflector 200 of the disclosed invention that is employed in the CLBA retro-reflector system of the disclosed invention. With reference to FIG. 2B, shown is the illustration of the section B shown in FIG. 2A. The structures shown in FIGS. 2A-2B are exaggerated for description purpose. The corner reflector 200 includes three reflective facets 201-203 that are configured to reflect rays and are not mutually perpendicular. The first facet angle 221, the second facet angle 222, and the third facet angle 223 between the facets 202 and 203, facets 201 and 203, and facets 201 and 202, respectively, may not be right angles, but may be acute angles (less than 90 degrees) or obtuse angles (greater than 90 degrees). The incident rays 211 enter the corner reflector 200 through the face facet 204 and make three reflections on the facets 201-203 of the corner reflector 200, before exiting the corner reflector 200 as reflected rays 212. In the corner reflector 200 of the disclosed invention, the reflected rays 212 do not travel at the exact opposite direction of the incident rays 211. The traveling directions of the reflected rays 212 are deviated from the opposite direction of the incident rays 211.

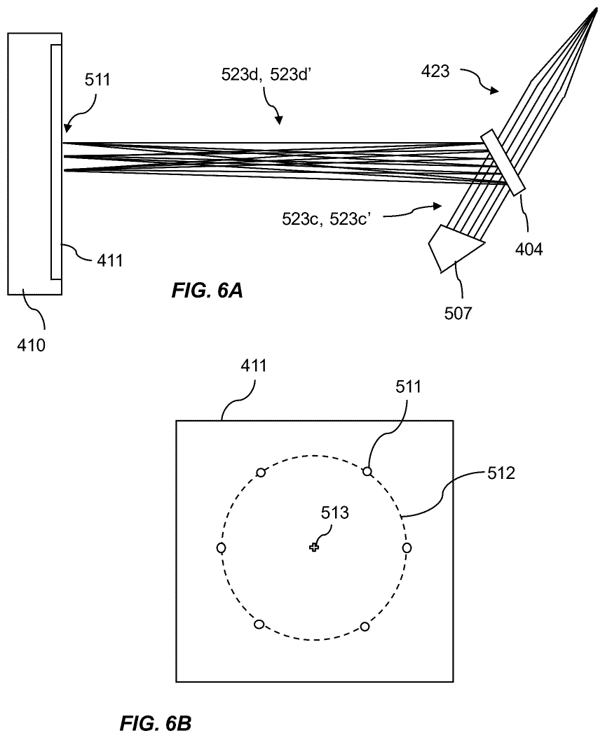

As a result, the reflected rays 212 of the six segments described above, which are the six possible sequences of reflections from the three facets 201-203: 1-2-3, 1-3-2, 2-3-1, 2-1-3, 3-1-2, and 3-2-1, propagate in different directions, all deviated from an axis of symmetry (see FIG. 6B). In this way, the reflected rays 212 of the six segments produce distinct retro-reflections, possibly six distinct retro-reflections. In an embodiment, the facet angles 221-223 are acute or obtuse angles, and are the same. In another embodiment, the facet angles 221-223 are acute or obtuse angles, and some or all of the angles 221-223 are different from one another. In another embodiment, facet angles 221-223 may be any angles including acute, obtuse, and right angles, and some or all of the angles 221-223 are different from each other.

The facets 201-203, which are not mutually perpendicular, may be achieved by adjusting angles 221-223 between two of the facets 201-203. Deviations in the angles between the facets 201-203 relative to the conventional corner reflector can be defined in terms of two rotation angles about orthogonal axes that are not themselves normal to the facets 201-203. The choice of these rotation axes is arbitrary, but a convenient choice is to select one rotation axis that is normal to both the facet normal and the global z axis (radial error), and to select the other rotation axis that is defined by the intersection of the plane of the facet and the plane containing both the surface normal and the global z axis (azimuth error).

For example, by using a facet deviation angle (Δα) of 0.001134 radian, the angles between three facets 201, 202, and 203 of the corner reflector 200 are calculated. When the deviation angle (Δα) is zero, it corresponds to the conventional corner reflector in which the facets are mutually perpendicular. Surface normal vectors N1, N2, and N3 of the mutually perpendicular facets are given as shown in equations (1), (2) and (3) below. In these equations, a surface normal vector of the face facet 104, 204 is along Z-axis, and the surface normal vector N1 lies in the y-z plane.

$$N 1 = ( \begin{matrix}0 \\ \sqrt{2 / 3} \\ - 1 / \sqrt{3}\end{matrix} ) \qquad ( 1 )$$

$$N 2 = ( \begin{matrix}1 / \sqrt{2} \\ - 1 / \sqrt{6} \\ - 1 / \sqrt{3}\end{matrix} ) \qquad ( 2 )$$

$$N 3 = ( \begin{matrix}- 1 / \sqrt{2} \\ - 1 / \sqrt{6} \\ - 1 / \sqrt{3}\end{matrix} ) \qquad ( 3 )$$

Surface normal vectors N1′, N2′, and N3′ of the facets 201, 202, and 203 of the corner reflector 200 with the deviation angle (Δα) are calculated with the following equations (4), (5), and (6).

$$N {1}^{′} = {R}_{α} ( a cos ( - N {1}_{z} ) - Δα ) \cdot ( \begin{matrix}0 \\ 0 \\ - 1\end{matrix} ) \qquad ( 4 )$$

$$N {2}^{′} = {R}_{γ} ( \frac{2 π}{3} ) \cdot {R}_{α} ( a cos ( - N {1}_{z} ) - Δα ) \cdot ( \begin{matrix}0 \\ 0 \\ - 1\end{matrix} ) \qquad ( 5 )$$

$$N {3}^{′} = {R}_{γ} ( \frac{4 π}{3} ) \cdot {R}_{α} ( a cos ( - N {1}_{z} ) - Δα ) \cdot ( \begin{matrix}0 \\ 0 \\ - 1\end{matrix} ) \qquad ( 6 )$$

where (0 0 −1) is the surface normal vector (Z-axis) of the face facet 204, and Rα and Rγ are rotation matrices about X-axis and Z-axis, respectively, as shown in equations (7) and (8) below.

$${R}_{α} ( α ) = ( \begin{matrix}1 & 0 & 0 \\ 0 & cos ( α ) & - sin ( α ) \\ 0 & sin ( α ) & cos ( α )\end{matrix} ) \qquad ( 7 )$$

$${R}_{γ} ( γ ) = ( \begin{matrix}cos γ & - sin ( γ ) & 0 \\ sin ( γ ) & cos ( γ ) & 0 \\ 0 & 0 & 1\end{matrix} ) \qquad ( 8 )$$

By using the equations (4) and (5), for example, the angle between the facets 201 (with normal vector N1′) and 202 (with normal vector N2′) is calculated with the following equation (9).

$$a cos ( N {1}^{′} \cdot N {2}^{′} ) = 89.9 \; 08 deg \qquad ( 9 )$$

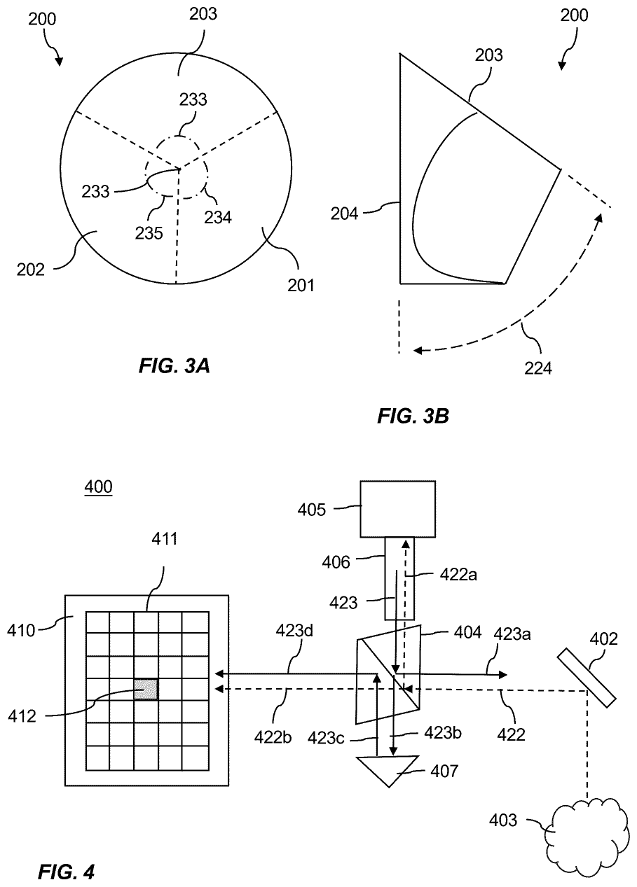

Likewise, by using equations (4) and (6) or equations (5) and (6), the angle between the facets 201 and 203 or between the facets 202 and 203, respectively, can be calculated. As shown in the exemplary calculations above, the angle between two facets becomes 89.908 degrees with the deviation angle (Δα) of 0.001134 radian. By using the equation (4), the nominal angle 224 (see FIG. 3B) between the face facet 204 and the facet 201 is calculated with the following equation (10).

$$a cos [ N {1}^{′} \cdot ( \begin{matrix}0 \\ 0 \\ - 1\end{matrix} ) ] = 54.67 deg \qquad ( 10 )$$

With the deviation angle (Δα) of 0.001134 radian, the nominal angle is 54.67 degrees. The corner reflector 200 of the disclosed invention may be manufactured to have the nominal angle 224 of 54.67 degrees between the face facet 204 and each of the facets 201-203. In this case, the angles between any two of the normal vectors of the facets 201-203 will be 89.908 degrees. Based on applications, the angles between any two of the normal vectors of the facets 201-203 may be in a range of 89.0 degrees to 90.0 degrees, typical, but this is not a hard limit and will vary with the application.

With reference to FIGS. 3A-3B, shown are exemplary diagrams of the corner reflector 200 of the disclosed invention showing a front view and a side view, respectively. FIG. 3A shows a front view of the corner reflector 200 seen from the face facet 204 along the direction 231 (see FIG. 2A). When viewed from the face facet 204, the three facets 201-203, projected on a plane parallel to the face facet 204, are equally divided with respect to the corner 233 of the corner reflector 200. FIG. 3B shows a side view of the corner reflector 200 seen from the side along the direction 232. The nominal angle 224 is defined as an angle between the face facet 204 and each of the facets 201-203. The corner reflector 200 of the disclosed invention may be constructed as a hollow configuration of surface mirrors or as a solid prism made of a transparent refractive material. FIG. 2A exemplarily shows a solid prism type corner reflector 200.

The face facet 204 of the corner reflector 200 may be formed with an anti-reflection (AR) coating on its surface. The AR coating may be optimized for wavelength of 1550 nm. However, depending on applications, the AR coating may not be necessary or may be optimized for other wavelengths such as 550 nm, 633 nm, 750 nm, 900 nm, and 1064 nm, etc. The facets 201-203 may be formed with a reflective coating on their surfaces such as layers of Al/SiO, Ag/Cu, Au/INCONEL, etc. However, the reflective coating may not be necessary.

With reference to FIG. 4, shown is an exemplary diagram of retro-reflector system 400 illustrating how a conventional corner reflector can be used to create an image of the receiver fiber on the focal plane array (FPA) which defines the boresight pixel location, thereby achieving a coalignment of the receiver fiber and boresight pixel of the FPA of a pointing/acquisition/track (PAT) camera. In this exemplary retro-reflector system 400, the corner reflector 407 may be the conventional corner reflector 100 shown in FIGS. 1A-1B. The diagram shown in FIG. 4 is exaggerated for description purpose.

Incoming beam 422 from the target or remote terminal 403 is steered by beam steerer 402, which may include a steering mirror, and is then received by beam splitter 404, and is split into two beams at the beam splitter 404. One of the split incoming beams 422a (first split incoming beam) is directed to receiver channel 405 through receiver fiber 406, and the other split incoming beam 422b (second split incoming beam) is directed to PAT camera 410 that may include focal plane array (FPA) 411. The receiver channel 405 detects or obtains information carried by the incoming beam 422 by receiving the first split incoming beam 422a. In bidirectional optical systems or a free-space optical communication systems, the PAT camera 410 uses the second split incoming beam 422b to measure a deviation angle of the incoming beam 422 with respect to a boresight pixel 412 in the FPA 411 of the PAT camera 410. Based on the measured angle, the PAT camera 410 provides a tracking error signal to the steering mirror 402 to steer the incoming beam 422 to place the focused incoming beam 422 precisely on the boresight pixel 412.

The optical amplifier in the receive fiber 406 amplifies the receiver signal 422a, and also amplifies spontaneously emitted photons which is the phenomenon referred to as amplified spontaneous emission (ASE) in a gain medium. The receiver fiber 406 works as a gain medium and generates the ASE flux or beam 423. The ASE beam 423 emitted by the receive fiber 406, propagates back into the direction of the incoming split beam 422a toward the beam splitter 404. The ASE beam 423 is split at the beam splitter 404 into two beams. One of the split ASE beams 423a propagates toward the target or remote terminal 403. The other split ASE beam 423b passes through the beam splitter 404 toward corner reflector 407 that is placed behind the beam splitter 404. The ASE beam 423b incident to the corner reflector 407 is reflected at the corner reflector 407, and the reflected ASE beam 423c is again split at the beam splitter 404 into two beams. One of the reflected split ASE beam 423d enters the FPA 411 of the PAT camera 410. The spot image of the reflected split ASE beam 423d on the FPA 411 is an image of the receiver fiber, and thus may be used as an alignment beam to locate the boresight pixel 412 of the FPA 411.

However, the retro-reflector system 400 employed in this manner cannot provide the desired built-in, real-time, closed-looped alignment of the receive fiber and the boresight pixel of the FPA because the spot image of the reflected split ASE beam 423d on the FPA 411 may not be distinguishable from the second split incoming beam 422b from the target or remote terminal 403. In addition, the reflected split ASE beam 423d incident to the FPA 411 may have much higher power than the second split incoming beam 422b from the target or remote terminal 403. Therefore, it may be advantageous to separate the spot image of the reflected split ASE beam 423d on the FPA 411 from the spot image of the incoming beam 422b.

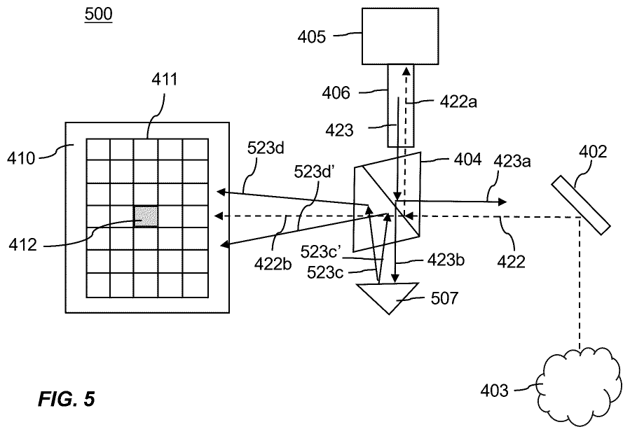

With reference to FIG. 5, shown is an exemplary diagram of closed loop boresight adjustment (CLBA) retro-reflector system 500 of the disclosed invention that utilizes the modified corner reflector 200 of the disclosed invention to provide for spatial separation of the spot images produced by the reflected split ASE beam and the incoming beam, thereby achieving a means for built-in, real-time coalignment of the receiver fiber and boresight pixel of the FPA 411 of the PAT camera 410. The difference between the retro-reflector systems 400 and 500 is the corner reflector 507 that is the modified corner reflector 200 shown in FIGS. 2A-2B in which the facets 201-203 are not mutually perpendicular. The diagram shown in FIG. 5 is exaggerated for description purpose.

The ASE beam 423, which is emitted by the receiver fiber 406, propagates toward the beam splitter 404 back into the direction of the first incoming split beam 422a. The ASE beam 423 is split at the beam splitter 404, and one of the split ASE beam 423a propagates toward the target or remote terminal 403. The other split ASE beam 423b passes through the beam splitter 404 toward the corner reflector 507 that is placed behind the beam splitter 404. The ASE beam 423b entering the corner reflector 507 is reflected at the corner reflector 507. In this case, as described above, the reflected ASE beam, for example, beam 523c, does not travel in the exact opposite direction of the incident ASE beam 423b. As a result, the reflected ASE beams 523c, 523c′, which are the six possible sequences of reflections from the three facets 201-203: 1-2-3, 1-3-2, 2-3-1, 2-1-3, 3-1-2, and 3-2-1, propagate in different directions. FIG. 5 exemplarily illustrates two reflected ASE beams 523c, 523c′ reflected in different directions at the corner reflector 507. Each of the reflected ASE beams 523c, 523c′ is again split at the beam splitter 404 into a first reflected split ASE beam 523d or 523d′ and a second reflected split ASE beam. The first reflected split ASE beams 523d, 523d′ enter the FPA 411 of the PAT camera 410. Because the reflected ASE beams 523c, 523c′ propagate in different directions, the split beams 523d, 523d′ also propagate in different directions. The six segments of reflections would produce six ASE beams propagating their own unique directions toward the FPA 411. In this way, the spot images of the ASE beams 523d, 523d′ on the FPA 411 are spatially separated from the spot image of the incoming beam 422b. The multiple spot images of the ASE beams 523d, 523d′ on the FPA 411 are all images of the receive fiber 406, and may be used as an alignment reference to locate the boresight pixel 412 of the FPA 411.

With reference to FIGS. 6A-6B, shown are illustrations showing how the reflected split ASE beams 523d, 523d′ make multiple spots 511 on the FPA 411 of the PAT camera 410. FIG. 6A shows the reflected split ASE beams 523d, 523d′ that are separated from each other and propagate in different directions. FIG. 6B shows an imaginary circular pattern 512 with a center point 513, along which the spots of the reflected split ASE beams 523d, 523d′ are distributed.

The retro-reflected ASE beams 523d, 523d′ from the corner reflector 507 provide suitable signals, because the circular distribution of spots 511 on FPA 411 will be centered on the focused spot that would be produced by the conventional corner reflector 100 which may locate the desired boresight pixel 412. Any two spots from this circular pattern 512 that are on opposite sides of the circular pattern can be used for an alignment algorithm that first finds the midpoint between these two spots, which is equivalent to the center point 513 of the circular pattern 512, which is the desired boresight pixel 412 location, and then commands the steering mirror 402 to align the spot produced by the incoming beam 422 to this midpoint. This action will in turn maximize the optical power delivered to the receive fiber 406.

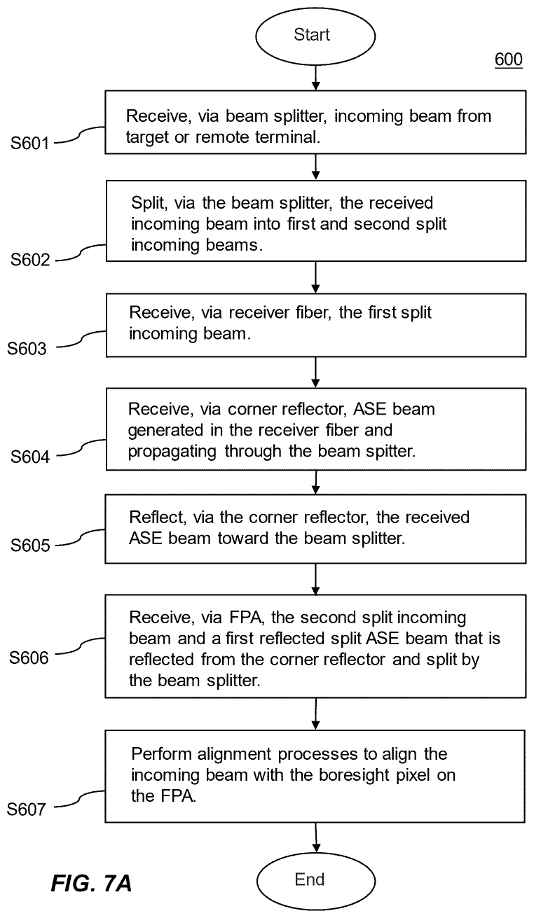

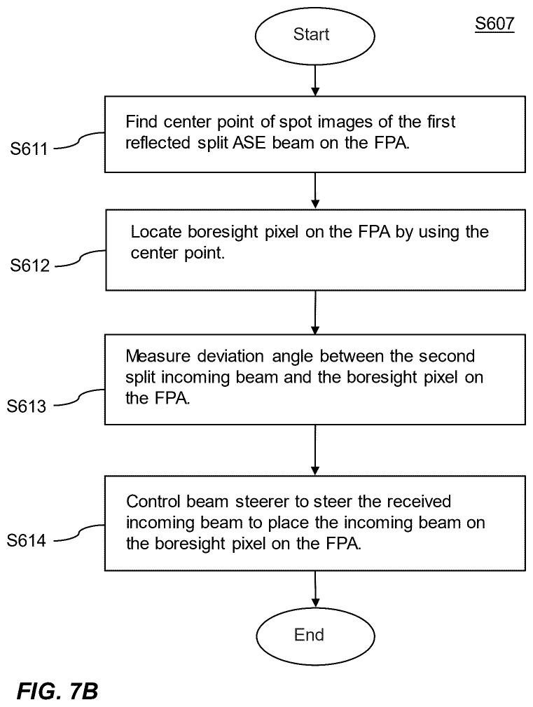

With reference to FIG. 7A, shown is a workflow diagram of method 600 of the disclosed invention for aligning an incoming beam with a boresight pixel on a FPA of a PAT camera. With reference to FIG. 7B, shown is a workflow diagram of steps included in the step S607 shown in FIG. 7A.

Referring to FIG. 7A, the incoming beam 422 from a target or a remote terminal 403 is received via beam splitter 404, block S601. The received incoming beam 422 is split into first split incoming beam 422a and second split incoming beam 422b via the beam splitter 404, block S602. The first split incoming beam 422a is received via receiver fiber 406, block S603. The receiver fiber 406 is configured to generate an amplified spontaneous emission (ASE) beam propagating toward the beam splitter 404. The corner reflector 507 receives the ASE beam 423b generated in the receiver fiber 406 and propagating through the beam splitter 404, block S604. The received ASE beam 423b is reflected via the corner reflector 507 toward the beam splitter 404, block S605. The FPA 411 receives the second split incoming beam 422b and first reflected split ASE beams 523d, 523d′ that is reflected from the corner reflector 507 and split by the beam splitter 404, block S606. Alignment processes to align the incoming beam with the boresight pixel 412 on the FPA 411 is performed, block S607.

The Alignment processes S607 may further include steps of finding a center point 513 of spot images 511 of the first reflected split ASE beams 523d, 523d′ on the FPA 411, block S611, locating the boresight pixel 412 on the FPA 411 by using the center point 513, block S612, measuring a deviation angle between the second split incoming beam 422b and the boresight pixel 412 on the FPA 411, block S613, and controlling the beam steerer 402 to steer the incoming beam to place the incoming beam 422 on the boresight pixel 412 on the FPA 411, block S614.

Since many modifications, variations, and changes in detail can be made to the described preferred embodiments of the invention, it is intended that all matters in the foregoing description and shown in the accompanying drawings be interpreted as illustrative and not in a limiting sense. Consequently, the scope of the invention should be determined by the appended claims and their legal equivalents.

What is claimed is:

1. A closed loop boresight adjustment (CLBA) retro-reflector system, comprising:
a beam splitter that receives an incoming beam from a target or a remote terminal, wherein the beam splitter is configured to split the incoming beam into a first split incoming beam and a second split incoming beam;
a receiver fiber that receives the first split incoming beam, wherein the receiver fiber is configured to generate an amplified spontaneous emission (ASE) beam propagating toward the beam splitter;
a corner reflector comprising a first facet, a second facet, and a third facet that are configured to reflect rays, wherein the first, second, and third facets are not mutually perpendicular to reflect an incident ray into multiple reflected rays, wherein the corner reflector is arranged to receive the ASE beam from the beam spitter and to reflect the received ASE beam toward the beam splitter; and
a pointing/acquisition/track (PAT) camera comprising a focal plane array (FPA), wherein the PAT camera is arranged to receive the second split incoming beam on the FPA and to receive on the FPA a first reflected split ASE beam that is reflected from the corner reflector and split by the beam splitter.

2. The CLBA retro-reflector system of claim 1 wherein a first angle between the second and third facets, a second angle between the first and third facets, and a third angle between the first and second facets are acute angles or obtuse angles, and are the same.

3. The CLBA retro-reflector system of claim 1 wherein a first angle between the second and third facets, a second angle between the first and third facets, and a third angle between the first and second facets are acute angles or obtuse angles, and some or all of the first, second, and third angles are different from each other.

4. The CLBA retro-reflector system of claim 1 wherein the corner reflector is constructed as a solid prism made of a transparent refractive material.

5. The CLBA retro-reflector system of claim 4 wherein a surface of the face facet is formed with an anti-reflection coating.

6. The CLBA retro-reflector system of claim 1 further comprising a receiver channel connected to the receiver fiber, wherein the receiver channel is configured to obtain information carried by the incoming beam.

7. The CLBA retro-reflector system of claim 1 further comprising a beam steerer that reflects the incoming beams from the target or the remote terminal and directs the reflected beam to the beam splitter.

8. The CLBA retro-reflector system of claim 7 wherein the PAT camera is configured to perform alignment processes comprising:
finding a center point of spot images of the first reflected split ASE beam on the FPA;
locating a boresight pixel on the FPA by using the center point;
measuring a deviation angle between the second split incoming beam and the boresight pixel on the FPA; and
controlling the beam steerer to steer the incoming beam to place the incoming beam on the boresight pixel on the FPA.

9. A method to align an incoming beam with a boresight pixel on a focal plane array (FPA) of a pointing/acquisition/track (PAT) camera, comprising:
receiving, via a beam splitter, the incoming beam from a target or a remote terminal;
splitting, via the beam splitter, the received incoming beam into a first split incoming beam and a second split incoming beam;
receiving, via a receiver fiber, the first split incoming beam, wherein the receiver fiber is configured to generate an amplified spontaneous emission (ASE) beam propagating toward the beam splitter;
receiving, via a corner reflector, the ASE beam from the beam spitter, wherein the corner reflector comprises a first facet, a second facet, and a third facet that are configured to reflect rays, wherein the first, second, and third facets are not mutually perpendicular to reflect an incident ray into multiple reflected rays;
reflecting, via the corner reflector, the received ASE beam toward the beam splitter;
receiving, via the FPA, the second split incoming beam and a first reflected split ASE beam that is reflected from the corner reflector and split by the beam splitter; and
performing alignment processes to align the incoming beam with the boresight pixel on the FPA.

10. The method of claim 9 further comprising:
directing the incoming beam from the target or the remote terminal to the beam splitter via a beam steerer.

11. The method of claim 10 wherein the performing alignment processes comprises:
finding a center point of spot images of the first reflected split ASE beam on the FPA;
locating the boresight pixel on the FPA by using the center point;
measuring a deviation angle between the second split incoming beam and the boresight pixel on the FPA; and
controlling the beam steerer to steer the incoming beam to place the incoming beam on the boresight pixel on the FPA.

12. The method of claim 9 wherein a first angle between the second and third facets, a second angle between the first and third facets, and a third angle between the first and second facets are acute angles or obtuse angles, and are the same.

13. The method of claim 9 wherein a first angle between the second and third facets, a second angle between the first and third facets, and a third angle between the first and second facets are acute angles or obtuse angles, and some or all of the first, second, and third angles are different from each other.

14. The method of claim 9 wherein the corner reflector is constructed as a solid prism made of a transparent refractive material.

15. The method of claim 14 wherein a surface of the face facet is formed with an anti-reflection coating.

16. The method of claim 9 further comprising receiving, via a receiver channel, the first split incoming beam through the receiver fiber, wherein the receiver channel is configured to obtain information carried by the incoming beam.
